(19) United States
(12) Patent Application Publication
(10) Pub. No.: US 2003/0046195 A1
(43) Pub. Date: Mar. 6, 2003

(54) Expense management system and method

(76) Inventor: Wenbo Mao, Shen Zhen (CN)

Correspondence Address: Wei Te Joseph Chung, Foxconn International, Inc., 1650 Memorex Drive, Santa Clara, CA, 95050, US

(21) Appl. No.: 09/976,928

(22) Filed: Oct. 11, 2001

(30) Foreign Application Priority Data
Sep. 5, 2001 (TW) 90121942

(51) Int. Cl. G06F 17/60

(52) U.S. Cl. 705/30

(57) ABSTRACT

An expense management method for controlling a budget of each department in an organization is provided in an operational environment which includes a plurality of terminal units electrically connected to a host via an electronic communications network. Firstly, a user stores a total budget of a department in the host. Secondly, a user sends a purchase requisition of the department from a terminal unit of that department to the host via the network. Thirdly, the host calculates a budget balance of the department according to the total budget and a history of expenses of the department that is stored in the host. Finally, the host determines if a total cost of the purchase requisition exceeds the budget balance of the department. If the total cost is within the budget balance, the host sends purchase order to an appointed supplier. Otherwise, the host sends an alarm to the user.

### BACKGROUND OF THE INVENTION

1. Field of the Invention

The present invention relates to expense management systems and methods, and more particularly to expense management systems and methods for controlling an entire purchasing process of a department so that purchases do not exceed a predetermined budget.

2. Description of the Related Art

Departments of a large organization need to purchase maintenance, repair and operating (MRO) materials such as paper, floppy disks and stationery for daily use. Normally, administrative staff of an organization collate total MRO material requirements of the organization periodically, by collecting purchase requisitions submitted by each department. The purchase requisition of each department is submitted to the administrative staff either in hardcopy form or by electronic means such as phone, fax, or e-mail. Generally each department manages its own budget regarding MRO materials, independently of other departments. It is therefore difficult for the administrative staff to collate and organize a variety of MRO material budgets from all departments into an overall MRO material budget for the entire organization. It is particularly difficult for the administrative staff to do so in a timely manner.

An order management system and method for solving the foregoing problem is disclosed in U.S. Pat. No. 5,799,289. The order management system comprises a terminal unit provided to each of several purchasers. Each terminal unit includes means for inputting order information to be transmitted to a communications network. A central management unit receives the order information from the terminal unit via the communications network. The central management unit includes collection processing means for managing order history information and department information related to each purchaser. The department information includes a budget for each purchaser. The central management unit also includes order permission means for permitting an execution of an order submitted by a purchaser. When a purchaser submits an order, the collection processing means calculates a total cost of previous orders based on the order history information of the purchaser, and a total cost of the order submitted. When the total cost of previous orders plus the total cost of the order submitted is calculated to be within the budget of the purchaser, the order permission means allows execution of the order submitted.

Unfortunately, the above order management system and method has limited scope. Execution of an ordering process can be approved only when the said calculation is within the budget of the purchaser. Otherwise, execution of the ordering process is rejected. In the case of rejection, the purchaser does not have any means for modifying the order to be able to purchase certain most wanted items and still stay within budget.

### SUMMARY OF THE INVENTION

A primary object of the present invention is to provide an expense management system and method which can calculate a total sum of a purchase requisition of a department of an organization, compare the total sum with a surplus budget of the department, and determine how to process the purchase requisition based on the comparison.

Another object of the present invention is to provide an expense management system and method for controlling operations of a purchase and thereby decreasing total expenses and overheads of an organization.

In order to accomplish the above-mentioned objects, an expense management method for controlling a budget of each department in an organization is provided in an operational environment which includes a plurality of terminal units electrically connected to a host via an electronic communications network. The expense management method comprises the following steps. Firstly a user stores a total budget of a department in the host. Secondly, a user sends a purchase requisition of the department from a terminal unit of that department to the host via the network. Thirdly, the host calculates a budget balance of the department according to the total budget and a history of expenses of the department that is stored in the host. Finally, the host determines if a total cost of the purchase requisition exceeds the budget balance of the department. If the total cost is within the budget balance, the host sends a purchase order to an appointed supplier. Otherwise, the host sends an alarm to the user for the user to reprocess the purchase requisition.

Additionally, there is provided according to another aspect of the present invention an expense management system for controlling expenses of each department in an organization. The expense management system comprises a basic information memory module for storing information about users' departments, costs of items, suppliers, forms and articles; a transaction process module for controlling purchase requirements, purchase processes and settlement of cost accounts; an inquiring and analyzing module for inquiring and analyzing information in the basic information memory module; a statistical reports module for gathering information from the basic information memory module; and a system management module for managing users' information and protecting system data from unauthorized change.

### BRIEF DESCRIPTION OF THE DRAWINGS

FIG. 1 is a schematic diagram of an operating environment of an expense management system in accordance with a preferred embodiment of the present invention;

FIG. 2 shows relationships among modules of the expense management system in accordance with the preferred embodiment of the present invention, including a basic information memory module;

FIG. 3 shows contents of a department master file of the basic information memory module of FIG. 2;

FIG. 4 shows contents of a supplier master file of the basic information memory module of FIG. 2;

FIG. 5 shows contents of an article master file of the basic information memory module of FIG. 2;

FIG. 6 is a flowchart of managing a budget using the expense management system in accordance with the preferred embodiment of the present invention; and

FIG. 7 is a flowchart showing operation of the expense management system in accordance with the preferred embodiment of the present invention.

### DETAILED DESCRIPTION OF A PREFERRED EMBODIMENT OF THE INVENTION

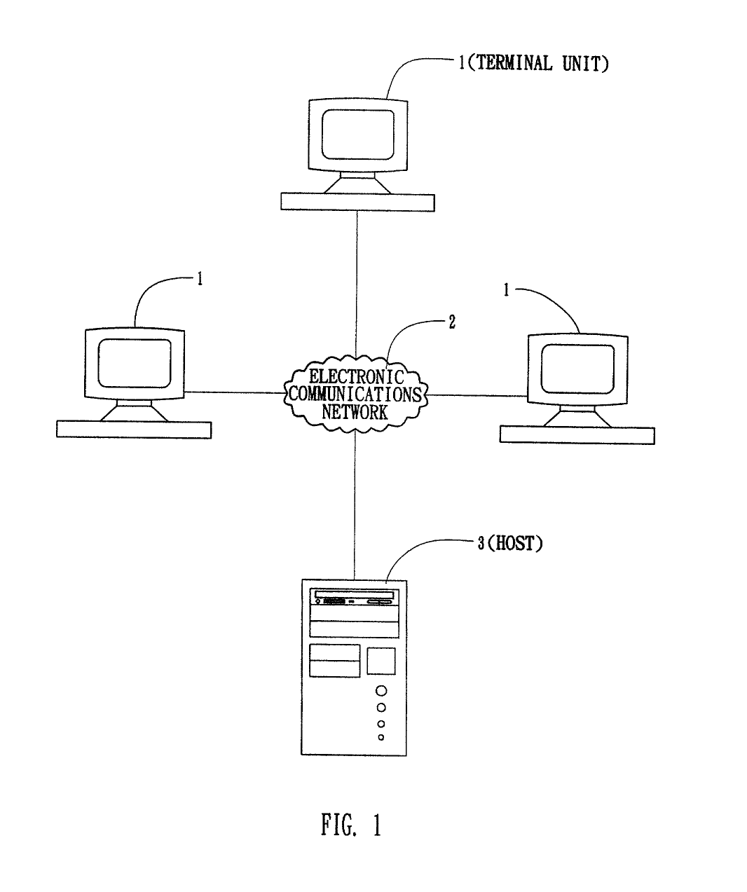

FIG. 1 is a schematic diagram of an operating environment of an expense management system in accordance with a preferred embodiment of the present invention. An electronic communications network 2 connects a plurality of terminal units 1 with a host 3. The terminal units 1 may be personal computers provided for users (not shown in FIG. 1). Each terminal unit 1 can be linked with a telephone, a fax machine or a scanner. The electronic communications network 2 can be an Ethernet, the Internet or an intranet.

A user can send a request from a terminal unit 1 to the host 3 via the electronic communications network 2. A user can use the terminal unit 1 to access information stored in the host 3. After receiving a specific request sent from any of the terminal units 1, the host 3 processes the request and feeds a response back to the relevant terminal unit 1.

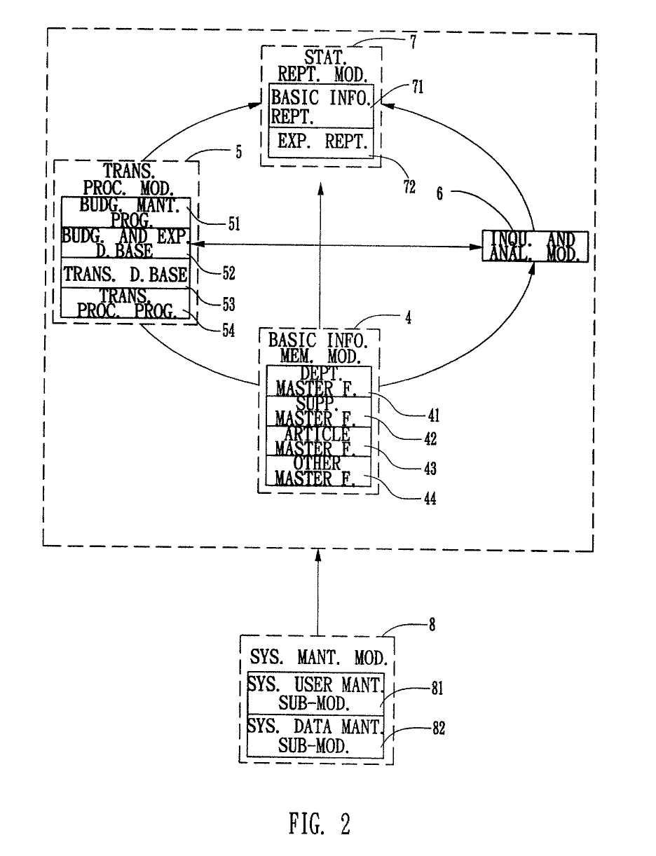

FIG. 2 shows relationships among modules of the expense management system in accordance with the preferred embodiment of the present invention. In the preferred embodiment, the host 3 comprises a basic information memory module 4, a transaction processing module 5, an inquiring and analyzing module 6, a statistical report module 7, and a system management module 8. The basic information memory module 4 is mainly used to store information about departments of an organization, suppliers, articles needed by the organization, and other related information. The information is stored in master file format. In the preferred embodiment of the present invention, the basic information memory module 4 comprises a department master file 41, a supplier master file 42, an article master file 43, and an other items master file 44.

The transaction process module 5 is mainly used to manage operations related to transactions, and comprises a budget management program 51, a budget and expense database 52, a transaction database 53 and a transaction process program 54. The budget management program 51 is used to control a budget of each department. The budget and expense database 52 is used for storing budget and expense information of each department generated from transactions. The transaction database 53 is used for storing information generated from transactions. The user 50 uses the transaction process program 54 to process specific transaction activities such as purchase requisitions, purchases, and budget management.

The inquiring and analyzing module 6 inquires about information contained in the basic information memory module 4. Such information includes data about forms, articles, departments and suppliers. With the inquiring and analyzing module 6, a user can confirm if an article to be purchased is already listed in the article master file 43. If the article is not listed in the article master file 43, the user needs to add the article to the article master file 43. The user can also choose suppliers by accessing the supplier master file 42.

The statistical report module 7 comprises a basic information reporter 71 and an expense reporter 72. The basic information reporter 71 generates department information reports, expense item reports, supplier information reports, and article classification reports. The expense reporter 72 generates current month budget reports, excess budget reports, budget information, and expense information. In the preferred embodiment of the present invention, a user can utilize the statistical report module 7 to conveniently print out a basic information report of a department, and to ascertain a current budget surplus and current expenses of a department.

The system management module 8 comprises a system user management sub-module 81 and a system data management sub-module 82. The system user management sub-module 81 manages basic information of users, including user classification, user department and user authorities. The system data management sub-module 82 comprises a department code management sub-module, a department budget locking management sub-module, and a form locking management sub-module. In the preferred embodiment of the present invention, if a department's code is changed, the system data management sub-module 82 automatically updates information in the department master file 41 of the basic information memory module 4. If a department's budget is not expected to be changed, the system management module 8 can set the department's budget to have read-only status. Thereupon, users cannot change the department's budget unless they have specific authority to do so. Similarly, the system management module 8 can set a department's forms filled in as a result of a transaction to have read-only status. The forms are thereby similarly protected from being changed.

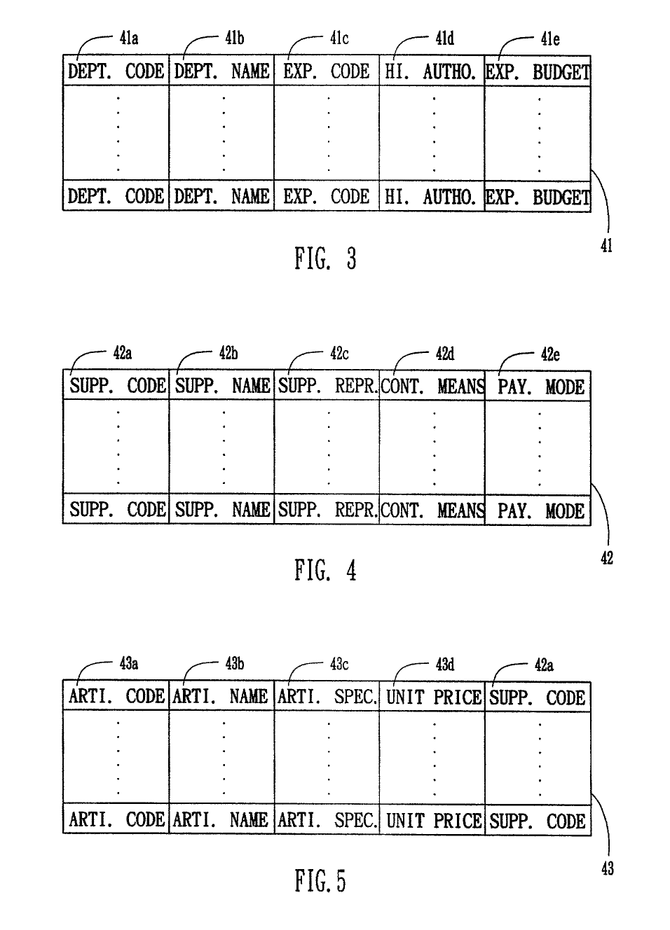

Referring to FIG. 3, the department master file 41 stores basic information of a department and a history of expenses of the department. The department master file 41 comprises a department code 41a, a department name 41b, an expense code 41c, a higher authority of the department 41d, and an expense budget 41e.

Referring to FIG. 4, the supplier master file 42 stores basic information on suppliers and supplier management. The supplier master file 42 comprises a supplier code 42a, a supplier name 42b, a supplier representative 42c, a contacting means 42d, and a payment mode 42e.

Referring to FIG. 5, the article master file 43 stores information comprising an article code 43a, an article name 43b, an article specification 43c, a unit price 43d and a supplier code 42a.

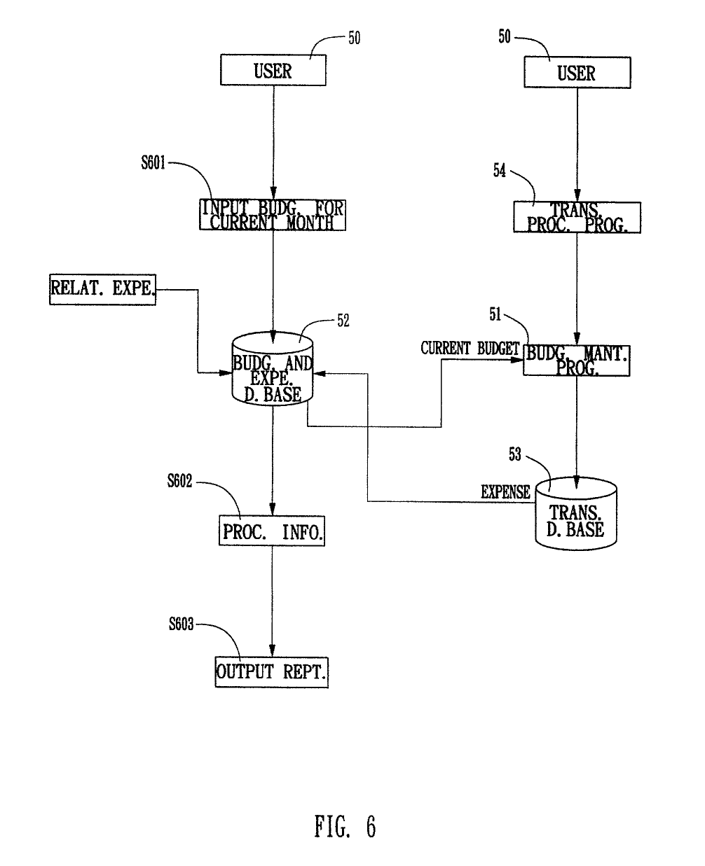

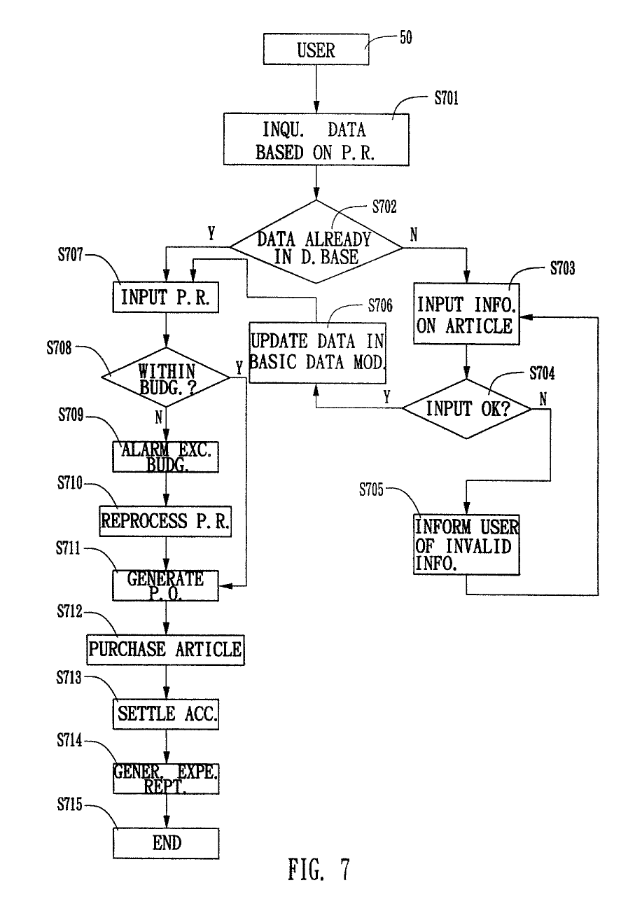

FIG. 6 is a flowchart of managing a budget using the expense management system of the preferred embodiment of the present invention. On one day each month, such as the first day of the month, a user 50 inputs that month's budget for a department (step s601). The budget is then stored in the budget and expense database 52. When a user 50 wants to purchase an article, he firstly inputs purchase requisition information in accordance with the transaction process program 54 stored in the user's terminal unit. The purchase requisition information comprises a department code, a name of the article to be purchased, and a quantity of the article required. The host 3 (see FIG. 1) retrieves a history of expenses of the department, calculates a current budget balance of the department using the budget management program 51, and compares the balance with a total cost of the purchase requisition. If the total cost is greater than the balance, the host 3 sends an alarm to the user. The alarm may take any one or more of a variety of forms, such as a sonic alarm or a visual alarm. A visual alarm may, for example, be a flashing red lamp. Upon receipt of the alarm, the user 50 must take action to reprocess the purchase requisition. If the total cost does not exceed the balance, the expense management system sends a purchase order to an appointed supplier. Transaction information generated from the purchasing process is stored in the transaction database 53, and expense information generated from the purchasing process is stored in the budget and expense database 52 automatically. The expense management system updates the budget balance and history of expenses information of the department. The statistical reports module 7 processes the information generated from the purchasing process (step s602), and outputs a report about the purchase (step s603).

FIG. 7 is a flowchart showing operation of the expense management system in accordance with the preferred embodiment of the present invention. When a user wants to find out whether information on a needed article already exists in the basic information memory module 4, he can input on his terminal unit a name and specification of the article and related supplier information. Such information is transmitted to the host 3 via the electronic communications network 2 as shown in step s701 (see also FIG. 1). The expense management system compares the information input by the user with information already stored in the host 3, to determine whether there already is information related to the article to be purchased in the basic information memory module 4. The determination is fed back to the user (step s702). If the determination is that there is no such information already in the basic information memory module 4, the result is negative. If the determination is that there already is such information in the basic information memory module 4, the result is positive. In the case of a negative determination, the user needs to input information about the article in the transaction process module 5. Information to be input includes name, specification, and unit price. The information is input in a specific format (step s703). Then the host 3 determines if the input information is both correct and sufficient (step s704). If not, the expense management system informs the user of “invalid information” (step s705). The user must then re-input the needed information; that is, repeat step s703. Once the user has input correct and sufficient information, the expense management system updates information in the basic information memory module 4 automatically (step s706), and information on the article is stored in the basic information memory module 4.

Once the information in the basic information memory module 4 has been updated, or when the result of the determination in step s702 is positive, the user can then post a purchase requisition on his terminal unit (step s707). The purchase requisition comprises name of article, quantity of article, ordering date, department code, and expense code. The host 3 calculates a total cost of the articles listed in the purchase requisition, and a budget balance of the department according to a history of expenses of the department. The host 3 then compares the total cost with the budget balance (step s708). If the total cost is greater than the budget balance, the expense management system gives the user an exceed budget warning (step s709). The user must then reprocess the purchase requisition, such as by abandoning it or modifying it (step s710). If the total cost does not exceed the budget balance, whether upon first posting of the purchase requisition or upon reprocessing thereof, the purchase requisition will be sent to a higher authority department (see FIG. 3) for approval. Assuming that the purchase requisition is authorized by the higher authority department, the host 3 then generates a purchase order according to the purchase requisition (step s711). Subsequently, the purchase order is sent to an appointed supplier (not shown in FIG. 7) for obtaining of the articles (step s712). After the user receives the articles that he needs, the host 3 settles accounts of the purchasing process (step s713) and generates an expense report (step s714). Thus the whole purchasing process is completed (step s715).

Although only an exemplary embodiment of the present invention has been described in detail above, those skilled in the art will readily appreciate that many modifications of the exemplary embodiment are possible without materially departing from the novel teachings and advantages of the present invention. Accordingly, all such modifications are intended to be included in the following claims.

What is claimed is:

1. An expense management method for controlling a budget of at least one department in an organization, the expense management method comprising the steps of:
providing at least one terminal unit and a host connected to each of the terminal units via an electronic communications network;
storing a budget of the at least one department in the host;
sending a purchase requisition of one department from a terminal unit of that department to the host via the network;
calculating a current budget balance of the said one department according to the stored budget and a history of expenses of the said one department in the host; and
determining if a total cost of the purchase requisition exceeds a current budget surplus of the said one department as disclosed by the calculation of the current budget balance.

2. The expense management method as claimed in claim 1, further comprising the step of:
sending a purchase order to a supplier if the total cost of the purchase requisition is less than the current budget surplus of the said one department.

3. The expense management method as claimed in claim 1, further comprising the step of:
sending an alarm if the total cost of the purchase requisition is greater than the current budget balance of the said one department.

4. The expense management method as claimed in claim 3, further comprising the step of:
reprocessing the purchase requisition if an alarm is sent.

5. The expense management method as claimed in claim 3, wherein the alarm sent is a sonic alarm.

6. The expense management method as claimed in claim 3, wherein the alarm sent is a visual alarm.

7. The expense management method as claimed in claim 1, further comprising the step of:
inquiring of the host about information stored in the host, the stored information including information relating to the at least one department, at least one article needed by any department, at least one supplier, and a history of expenses of each of the at least one department.

8. The expense management method as claimed in claim 1, further comprising the step of:
automatically generating a budget report, an expense report and an excess budget report.

9. An expense management system for controlling a budget of at least one department in an organization, the expense management system comprising:
a basic information memory module for storing information about each of the at least one department, a cost of any article needed by any of the at least one department, at least one supplier, and at least one form;
a transaction process module for controlling purchase requisitions, purchase activity and settlement of cost accounts;
an inquiring and analyzing module for inquiring and analyzing information in the basic information memory module;
a statistical reports module for collecting information in the basic information memory module and information related to costs; and
a system management module for managing information on users and changing data records in the basic information memory module.

10. The expense management system as claimed in claim 9, wherein the basic information module comprises a department management module for managing basic information on any of the at least one department.

11. The expense management system as claimed in claim 9, wherein the basic information module further comprises a cost item management module for managing cost items related to transactions of any of the at least one department.

12. The expense management system as claimed in claim 9, wherein the basic information module further comprises a supplier management module for managing basic information on suppliers.

13. The expense management system as claimed in claim 9, wherein the basic information module further comprises a forms management module for storing basic forms used in transactions.

14. The expense management system as claimed in claim 9, wherein the basic information module further comprises an article management module for storing information on articles purchased.

15. The expense management system as claimed in claim 9, wherein the transaction process module comprises a budget and expense database for storing budget and expense information on any of the at least one department generated from transactions.

16. The expense management system as claimed in claim 9, wherein the transaction process module further comprises a budget management program for controlling a budget of any of the at least one department.

17. The expense management system as claimed in claim 9, wherein the transaction process module further comprises a transaction database for storing information generated from transactions.

18. The expense management system as claimed in claim 9, wherein the transaction process module further comprises a transaction process program for executing specific transactions.

19. The expense management system as claimed in claim 9, wherein the system management module comprises an updating sub-module for managing changes in department code of any of the at least one department.

20. The expense management system as claimed in claim 9, wherein the system management module further comprises a department budget locking sub-module for protecting a budget of any of the at least one department from being changed.

21. The expense management system as claimed in claim 9, wherein the system management module further comprises a form locking sub-module for protecting forms used in transactions from being changed.

22. An expense management system comprising:
means for storing information of a budget of a department;
means for comparing a purchase order with the budget;
means for sending an alarm to the department if a monetary amount of said purchase order exceeds the budget or for processing the purchase order if not exceeds; and
means for updating the information before comparing the purchase order with the budget.
